(19) United States
(12) Patent Application Publication
(10) Pub. No.: US 2012/0278078 A1
(43) Pub. Date: Nov. 1, 2012

(54) INPUT AND DISPLAYED INFORMATION DEFINITION BASED ON AUTOMATIC SPEECH RECOGNITION DURING A COMMUNICATION SESSION

(75) Inventors: Christopher Ricci, Cherry Hills Village, CO (US); Shane Ricci, Cherry Hills Village, CO (US)

(73) Assignee: AVAYA INC., Basking Ridge, NJ (US)

(21) Appl. No.: 13/094,475

(22) Filed: Apr. 26, 2011

(51) Int. Cl. G10L 15/04

(52) U.S. Cl. 704/251; 704/E15.001

(57) ABSTRACT

Methods and systems for providing contextually relevant information to a user are provided. In particular, a user context is determined. The determination of the user context can be made from information stored on or entered in a user device. The determined user context is provided to an automatic speech recognition (ASR) engine as a watch list. A voice stream is monitored by the ASR engine. In response to the detection of a word on the watch list by the ASR engine, the context engine is notified. The context engine then modifies a display presented to the user, to provide a selectable item that the user can select to access relevant information.

### FIELD

The present invention is directed to defining the function of an input and/or displayed information based on automatic speech recognition during a communication session. More particularly, a current context of a user combined with automatic speech recognition of real time speech is used to define inputs or information presented to a user.

### BACKGROUND

During a phone call, dictation session or other telecommunications use of a device, users sometimes need to look up certain facts, contacts, lists, or other such information as efficiently as possible. This can be difficult because launching a web browser can take over the device screen. Similarly, speed dial buttons, rolodexes, menus and such are typically fixed, and reprogramming them on the fly is not easily done in parallel with real time speech. Therefore, there is a need for an effective and automated means for updating speed dial buttons, rolodexes, menus or the like.

A communications session can include a person to person, conference, or dictation session. In connection with speech, automatic speech recognition (ASR) is a well known technology that allows keywords to be spotted. ASR systems have been used to scroll keywords to a telephone or other device display and, in response to a user selection, triggering a viral search using the user selected words. Accordingly, the user must give attention to the scrolling text in order to use the system.

Other systems have provided speed dial associations that can be updated or varied based on call history or logs. For example, systems in which frequently used telephone numbers are stored in a first memory of the phone and less frequently used numbers are stored in a second memory of the phone have been proposed. However, such systems have been limited to configuring the dialing options of a telephone. In addition, such systems have not been capable of monitoring aspects of a call or other communication session that is in progress in order to modify the presented options.

Still other systems can assign a telephone number to a speed dial button based on communication information. For example, a speed dial button can be assigned the telephone number identified in an electronic message, including a text or a voice message. Again, such systems do not provide for the reconfiguration of options or information presented to a user based on the application of ASR to the content of an in-progress communication session.

### SUMMARY

Embodiments of the present invention are directed to solving these and other problems and disadvantages of the prior art. In accordance with embodiments of the present invention, a user context is determined. The determined user context provides a basis from which keywords that are of immediate interest to the user can be identified. The identified keywords are then provided as watch items to an automatic speech recognition (ASR) engine monitoring real time speech provided as part of a communication session. Such speech can be a dictation session, a two party call or a three or more party teleconference. Based on the current context of the user, combined with ASR of real time speech, associated data is offered as reprogramming options to the user. These reprogramming options can include, for example and without limitation, a list of projects, part numbers, relevant documents, or contacts.

In accordance with embodiments of the present invention, the user context can be obtained in various ways. For example, information stored as part of the user's electronic messaging, calendar, and/or contact information stored on a user computer, meeting attendee identity, open files, and other such contextual information. From this contextual information, a contextual watch list of words, acronyms, numbers, and the like are created and provided to the ASR engine. During a real time speech communication session, the identification by the ASR engine of a word or other entry in the watch list can result in the reprogramming of some aspect of a user device. This reprogramming can include providing an option to contact a specialist in a particular subject, access a particular document, access a particular set of data, or the like.

Systems in accordance with embodiments of the present invention include a context determining application that monitors data and activity on or associated with a user device. The system additionally includes an ASR engine capable of monitoring real time speech and of identifying keywords placed on a watch list for the ASR engine by the context monitoring application. The system can also include a device display, through which information identified as a result of the detection of a word on the watch list by the ASR system is presented to the user. Such information can take various forms, such as buttons or menus that allow the user to contact an individual having knowledge related to an identified word on the watch list, or items that can be selected to access documentation related to the identified keyword.

Additional features and advantages of embodiments of the present invention will become more readily apparent from the following description, particularly when taken together with the accompanying drawings.

### BRIEF DESCRIPTION OF THE DRAWINGS

FIG. 1 is a functional block diagram depicting aspects of a system for providing contextually relevant information to a user;

FIG. 2 is a block diagram depicting components of a system in accordance with embodiments of the present invention;

FIG. 3 depicts an exemplary device display in accordance with embodiments of the present invention; and

FIG. 4 is a flowchart depicting aspects of the operation of a system in accordance with embodiments of the present invention.

### DETAILED DESCRIPTION

The present invention provides a system and method for providing relevant information to a user in connection with a real time voice communication. More particularly, a current context that is relevant to the user is determined. This relevant context is associated with keywords. Automatic speech recognition (ASR) is applied to a voice communication session associated with the user, with the identified keywords providing a watch list. In response to the detection of a word in the watch list, information is presented to the user. This information is relevant to the determined context and/or to the detected word. The information can be in the form of a document or other data, or can provide or reconfigure an input that can be selected by the user to establish a connection to a source of information, such as an expert or other individual.

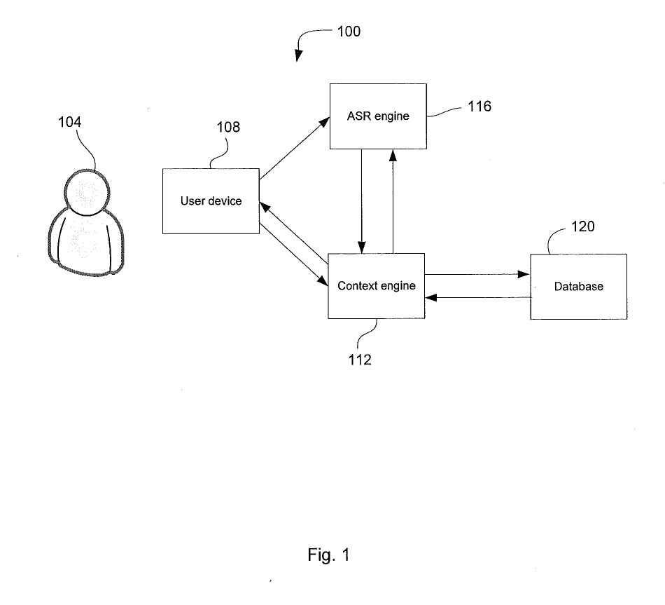

FIG. 1 is a functional block diagram depicting aspects of a system 100 for providing contextually relevant information to a user 104 in accordance with embodiments of the present invention. The system 100 includes a user device 108 with which the user 104 interacts. A context engine 112 is provided that operates to determine a context relevant to the user 104 from information available through or in association with the user device 108. Information providing a relevant context can include information stored in a personal information manager associated with the user 104, keystrokes or other input entered at the user device 108, information viewed through the user device 108, or the like.

In addition to collecting context information, the context engine 112 can analyze that information to identify relevant keywords. The identified keywords can be provided by the context engine 112 to an automatic speech recognition (ASR) engine 116. In particular, the ASR engine 116 can use the words provided by the context engine 112 as a watch list. Specifically, speech input associated with the user 104 can be provided to the ASR engine 116. The ASR engine 116 may then monitor a voice data stream for words on the watch list. In response to detecting a word in the watch list, the ASR engine 116 may notify the context engine 112. Such notification can include an identification of the particular word that has been identified.

The context engine 112 can provide information to the user device 108 in response to the identified word. The information can be provided in various forms, including as links to files, web pages, contacts or other sources of information. The information provided by the context engine to the user device 108 can be obtained from or can be determined at least in part by referencing an associated database 120.

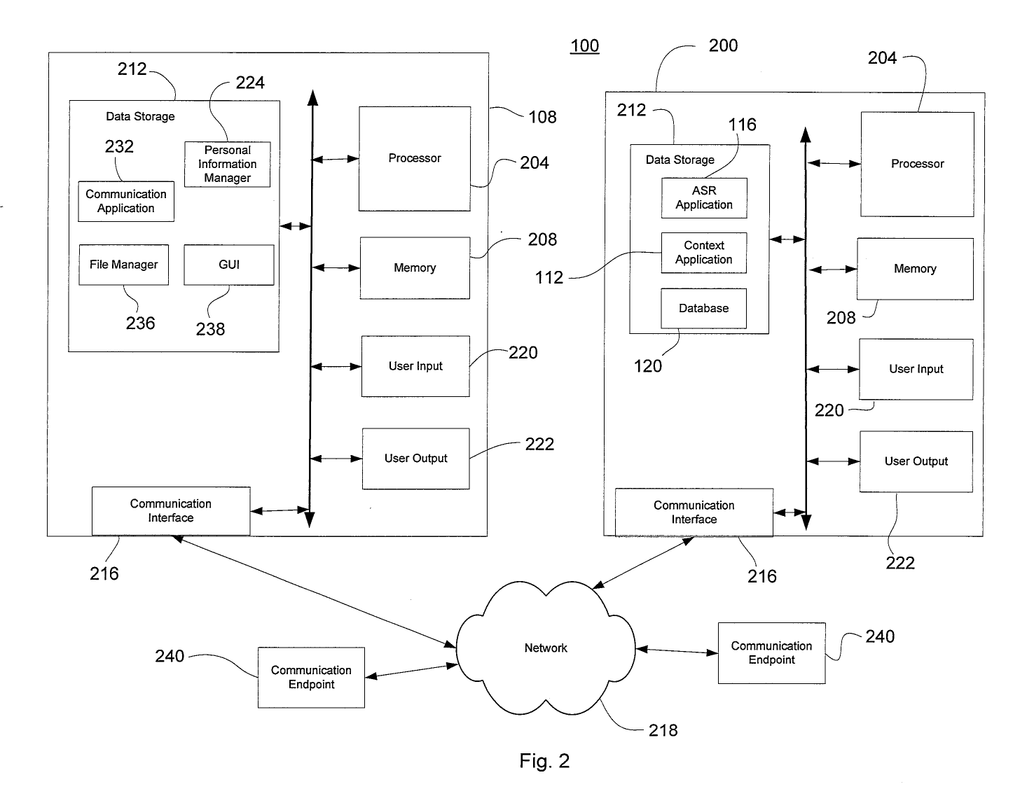

FIG. 2 is a block diagram depicting components of a system 100 in accordance with embodiments of the present invention. In particular, FIG. 2 depicts a user device 108 that is interconnected to a feature or communication server 200. In this exemplary embodiment, the feature server 200 provides a context engine 112, ASR engine 116, and database 120. As can be appreciated by one of skill in the art after consideration of the present disclosure, various functions of a system 100 in accordance with embodiments of the present invention can be integrated with or distributed among different devices according to the design considerations of particular implementations. Therefore, embodiments of a system 100 as disclosed herein are not limited to the illustrated embodiment.

The user device 108 and/or the feature server 200 can generally comprise general purpose computers. Accordingly, a user device 108 and feature server 200 can each include a processor 204. The processor 204 may comprise a general purpose programmable processor or controller for executing application programming or instructions. As a further example, the processor 204 may comprise a specially configured application specific integrated circuit (ASIC). The processor 204 generally functions to run programming code or instructions implementing various functions of the device with which it is incorporated.

A user device 108 and a feature server 200 also may include memory 208 for use in connection with the execution of programming by the processor 204, and for the temporary or long term storage of program instructions and/or data. As examples, the memory 208 may comprise RAM, SDRAM, or other solid state memory. Alternatively or in addition, data storage 212 may be provided. In accordance with embodiments of the present disclosure, data storage 212 can contain program code or instructions implementing various of the applications or functions executed or performed by the associated device 108 or 200, and data that is used and/or generated in connection with the execution of applications and/or the performance of functions. Like the memory 208, the data storage 212 may comprise a solid state memory device. Alternatively or in addition, the data storage 212 may comprise a hard disk drive or other random access memory.

A user device 108 and feature server 200 may additionally include a communication interface 216. The communication interface 216 can operate to support communications with other devices over a network 218. In accordance with embodiments of the present invention, the network 218 can include one or more networks. Moreover, the network or networks 218 are not limited to any particular type. Accordingly, the network 218 may comprise the Internet, a private intranet, a local area network, the public switched telephony network, or other wired or wireless network. The user device 108 and/or the feature server 200 may additionally include a user input 220 and a user output 222. Examples of a user input 220 include a microphone or other speech or voice input, a keyboard, a mouse or other position encoding device, a programmable input key, or other user input. An example of a user output 222 include a display device, speaker, signal lamp, or other output device.

In connection with the user device 108, the data storage 212 can include various applications and data. For example, the data storage 212 may include a personal information manager 224. A personal information manager 224 is an application that can provide various features, such as electronic calendar, contacts, email, text messaging, instant messaging, unified messaging or other features. Moreover, as described herein, the contents of the personal information manager 224 can include information particular to the user 104 that can be accessed by the context engine 112 in order to determine a current context relevant to the user 104.

In the exemplary embodiment of FIG. 2, the user device 108 may additionally include a communication application 232. Examples of a communication application include a soft phone, video phone, or other communication application. Moreover, the communication application 232 can comprise a speech communication application 232. In accordance with embodiments of the present invention, the communication application 232 can include configurable features. More particularly, features of the communication application 232 can be configured in response to the operation of the context application 224 in combination with the ASR engine 116.

A file manager application 236 can also be included in the data storage 212 of the user device 108. The file manager 236 can comprise a utility or other application that presents files, such as documents, to the user 104, to enable or facilitate user selection of a displayed file. Moreover, the file manager 236 can comprise or can operate in association with a graphical user interface (GUI) 238 provided by the user device 108. In accordance with embodiments of the present invention, the files displayed by the file manager 236, and/or selectable items presented by the GUI 238, can be determined, at least in part, through operation of the context engine 112 in cooperation with the ASR engine 116 as described in further detail elsewhere herein.

A feature server 200 can provide various functions in connection with the system 100. In the illustrated example, the feature server 200 can provide a context engine 112, ASR engine 116, and database 120. Therefore, in accordance with such a configuration, the data storage 212 of the feature server 200 generally includes programming or code implementing an ASR application or engine 116, a context application or engine 112, and a database 120.

The context engine 112 operates at least in part to identify a context relevant to the user 104 of the user device 108. The information accessed by the context engine 112 to identify a current user 104 context can include information stored on or in association with the user device 108, information accessed by the user device 108, and information obtained from inputs associated with the user's 104 operation of the user device 108. From the determined context information, the context engine 112 can further operate to identify keywords indicative of or related to the determined context.

The ASR engine 116 can operate to monitor a received voice stream. Moreover, in accordance with embodiments of the present invention, the ASR engine 116 can receive a real time voice stream associated with a user 104, and can monitor the voice stream for keywords provided as a watch list by the context engine 112 to the ASR application 248. Moreover, the ASR engine 116 can operate to notify the context engine 112 when a word on the watch list has been identified in monitored speech.

The database 120 can operate as a store of information. More particularly, the database 120 can provide information that is relevant to the determined context of the user device 108. As an example, where a first category of information is determined to be relevant to the user 104, the database 120 can provide information that can be used to link or connect the user device 108 to additional information related to that first category of information. Alternatively or in addition, the database 120 can itself provide such additional information.

A system 100 in accordance with embodiments of the present invention can additionally include one or more communication endpoints 240. A communication endpoint 240 can comprise, for example but without limitation, a telephone, a smart phone, a personal computer, a voicemail server or other feature server, or other device that is capable of exchanging information with a user device 108. As shown, a communication endpoint 240 can be interconnected to the user device 108 and the feature server 200 via the communication network 220. Alternatively, such connections can be made directly.

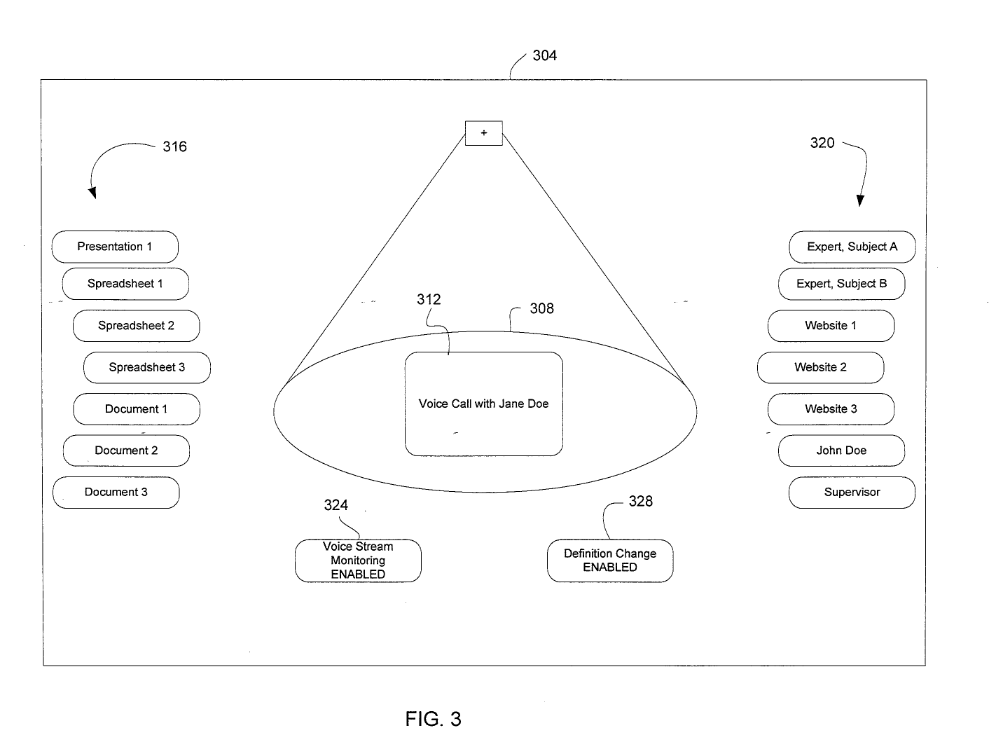

FIG. 3 illustrates an exemplary display 304 of a user device 108 comprising a generated by or in connection with the operation of the GUI 238 in accordance with embodiments of the present invention. The display 304 includes a spotlight or current activity area 308. The spotlight area 308 in this example indicates via a status box or icon 312 that the user 104 is engaged in a real-time communication session with an individual, for example in associated with a communication endpoint 240. In addition, the display 304 includes rolodex or menu listings of selectable items. More particularly, a first rolodex or listing 316 includes a listing of files that can be opened or otherwise accessed by the user 104 by clicking on or touching the associated entry. Examples of files that can be accessed include text documents, spreadsheets, tables, databases, photos, videos, or other files. The second rolodex or listing 320 includes links to sources of information. These links can include links to individuals, or links to web pages, video feeds, or other dynamic sources of information. The links to individuals can be static, or can be dynamic, based on presence. Moreover, links to individuals can be presented in the form of links to experts or gurus that are identified by the subject or subjects of their expertise, rather than as an individual identity. Accordingly, by clicking on a link or selectable item in the first 316 or second 320 listings, the user 104 can access or can be placed in contact with a source of information.

As shown, a voice stream monitoring a radio button or item 324 can be provided to the user 104, to enable the user to enable or disable monitoring a user voice stream or speech. In addition, a definition change radio button or item 328 can be provided to enable the user to enable or disable the dynamic definition of items in the lists of items 316 and 320 in response to the operation of the context engine 112 and ASR engine 116. Accordingly, a user can enable or disable the dynamic definition of items in the lists of items 316 and 320 in view of the determined context of the user 104, and in view of the detection of one or more keywords in monitored speech through operation of the ASR engine 116.

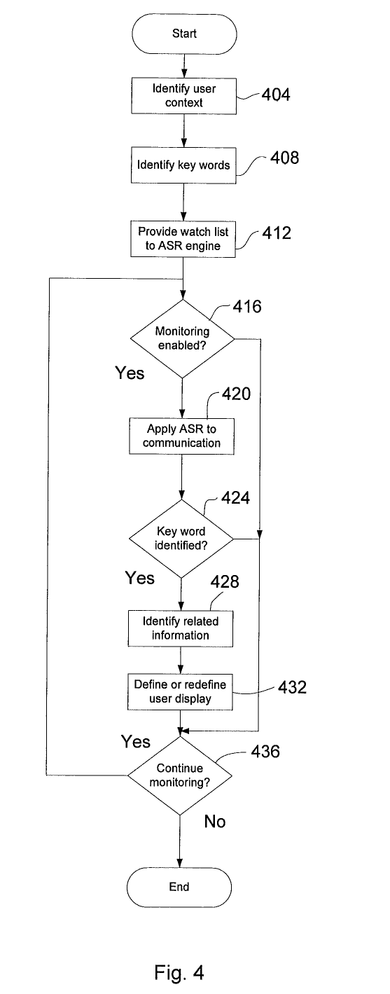

With reference now to FIG. 4, aspects of the operation of a system for providing contextually relevant information to a user 100 in accordance with embodiments of the present invention are illustrated. Initially, at step 404, the system 100, and in particular the context engine 112, operates to identify a user 104 context (step 404). Identifying the user 104 context can include the context engine 112 accessing the user device 108 and the context engine 112 reviewing or assessing the information contained on the user device 108, or information accessed via the user device 108 by the user 104. In accordance with further embodiments, the determination of the user 104 context can include monitoring keystroke and mouse activity, touches on a touch screen, open files, communication sessions, calendar events, surveys, and the like. From the determined context, keywords are identified (step 408). As examples, keywords can include, but are not limited to, subjects, products, companies, persons, or other words that are related to the determined user 104 context. The identification of key words from the identified context can be performed by the context engine 112. The identified keywords can in turn be used to create a watch list that can be provided by the context engine 112 to the ASR engine 116 (step 412). In accordance with further embodiments of the present invention, the keywords that are identified from the user 104 context can, in addition to being included in the watch list, be used to identify additional watch list items. For example, variations of keywords identified from the context 104 directly can be added to the watch list. As a further example, synonyms, related terms or subjects, and related words can be added to the watch list.

At step 416, a determination may be made as to whether the user 104 has enabled monitoring of voice communication sessions. If monitoring has been enabled, for example by selection of a voice stream monitoring enable button 324, automatic speech recognition is applied to an in-progress or a next communication session of the user 104 (step 420). For example, by enabling monitoring of real time communication sessions through a selection of the monitoring feature entered on the user device 108, a next or in-progress communication session performed in association or through the user device 108 will be monitored. In accordance with still other embodiments of the present invention, monitoring can be initiated for real time communication sessions of the user 104 that are monitored by the feature server 200, but that are not necessarily made through the user device 108, for example, enabling monitoring through the user device 108 or otherwise can activate monitoring of a communication session of the user 104 through some other communication device to which the feature server 200 has or is granted access.

At step 424, a determination is made as to whether a keyword on the watch list has been identified. If a keyword has been identified, the context engine 112 is notified of the keyword identified by the ASR engine 116, and the context engine 112 operates to identify related information or sources of information (step 428). The identified information is then used by the context engine 112 to define or redefine items in the user display 304 (step 432). For instance, if the determined context of the user 104 relates to a product line, and the identified keyword is pricing, the context engine 112 may operate to redefine or otherwise control the display 304 to present a list of links 320 that includes a link to an individual who is an authority on pricing related to the relevant product line. In addition, the listing of files 316 can include items comprising spreadsheets containing pricing information related to the relevant product line. At step 436, a determination is made as to whether monitoring is to be continued. If monitoring is to be continued, the process can return to step 416. Alternatively, the process may end.

Although various examples have been discussed in which various features of the system 100 are provided by a feature server 200, other system 100 architectures can be provided. For example, the context engine 112, ASR engine 116, and database 120 can all be provided by a user device 108. As another example, the system 100 can incorporate and/or access one or more separately provided databases 120.

In addition, although a user device 108 comprising a graphical user interface 238 display 304 has been discussed, a client device 108 can include other user input 220 and user output 222 facilities. For instance, embodiments of the present invention can be implemented in connection with a user device 108 comprising a telephone having one or more programmable function keys. Operation of the system 100 in such an embodiment can include re-defining a function key to operate as a speed dial button to enable the user to contact an expert in a subject, related to the user context and to a key word detected in monitored speech. Moreover, in such embodiments, the context can be determined from a user device 108 that is in addition to the telephone, and/or can be manually specified to the context engine 112 by the user 104.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A method for providing configurable communication device features, comprising:
determining a context relevant to a first user;
monitoring a voice stream associated with the first user using an automatic speech recognition system;
detecting at least a first word in the monitored voice stream using the automatic speech recognition system that is relevant to the determined context;
in response to detecting the first word that is relevant to the determined context, presenting at least first information to the first user.

2. The method of claim 1, wherein determining a context relevant to the first user includes at least one of the following: monitoring keystrokes, mouse activity, communications sessions, calendar events, surveys, and accessed documents and information on a first user device.

3. The method of claim 1, wherein determining a context relevant to the first user includes analyzing contents of a personal information manager associated with the user.

4. The method of claim 1, wherein presenting at least first information to the first user includes displaying the first information to the user through a display of a first user device.

5. The method of claim 1, wherein the first information is in a form of a link to a source of information.

6. The method of claim 5, wherein the link to a source of information is a speed dial button programmed to launch a communication session with an individual.

7. The method of claim 1, further comprising:
determining a list of keywords from the determined context relevant to the first user, wherein the detected at least a first word is a word included in the list of keywords.

8. The method of claim 1, wherein the voice stream is a real-time voice stream.

9. The method of claim 8, wherein the voice stream is a voice communication session including the user and at least one other party.

10. The method of claim 8, wherein the voice stream is a user dictation session.

11. A system, comprising:
data storage, including:
programming operable to identify a communication context relevant to a first user;
programming implementing an automatic speech recognition engine;
programming operable to provide information to the first user in response to the identification of a keyword by the automatic speech recognition system of a word determined to be relevant to the first user by the programming operable to identify a communication context relevant to the first user.

12. The system of claim 11, further comprising:
a plurality of user input devices, including:
a speech input device, wherein the automatic speech recognition engine monitors speech provided by the speech input device;
a configurable selection input, wherein in response to a user selection of the configurable selection input a request for additional information related to the provided information is initiated.

13. The system of claim 12, further comprising:
a display device, wherein the provided information is presented to the user by the display device.

14. The system of claim 13, wherein the configurable selection input is provided in association with the display device.

15. A system, comprising:
an automatic speech recognition system;
a user device, including:
data storage, wherein context information related to a first user is stored;
a speech input device;
a configurable display, wherein the configurable display is operable to display information related to the first user context information in response to the identification by the automatic speech recognition engine of a word related to the context information and the displayed information.

16. The system of claim 15, the user device further including:
a user input device, wherein the first user can access additional information related to the displayed information by providing a selection input through the user input device.

17. The system of claim 16, the user device further including:
a communication network interface, wherein in response to providing the selection input through the user input the device a communication channel to a first information source is established.

18. The system of claim 17, wherein the communication channel is a voice communication session with an individual.

19. The system of claim 17, wherein the communication channel transmits data for display on the configurable display of the user device.

20. The system of claim 15, further comprising:
a communication network;
a server computer, wherein the automatic speech recognition system is implemented by the server computer, and wherein the server computer is in communication with the user device over the communication network.
